(19) United States
(12) Patent Application Publication
(10) Pub. No.: US 2009/0322775 A1
(43) Pub. Date: Dec. 31, 2009

(54) IMAGE PROCESSING APPARATUS FOR CORRECTING PHOTOGRAPHED IMAGE AND METHOD

(75) Inventor: Yasuo Fukuda, Tokyo (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/491,031

(22) Filed: Jun. 24, 2009

(30) Foreign Application Priority Data
Jun. 27, 2008 (JP) 2008-169484

(51) Int. Cl. G09G 5/00; G06K 9/46; G06K 9/00

(52) U.S. Cl. 345/581; 382/190; 382/165; 345/634

(57) ABSTRACT

An image processing method includes detecting image features including a human face from an image, performing ranking of the detected image features, determining an image processing condition such as an image processing parameter based on an image feature ranked highest in the ranking, performing image processing on the image based on the image processing condition and displaying an image which was subjected to the image processing. The image processing method includes, when an instruction to change the image feature used in determining the image processing condition is received, redetermining the image processing condition based on the image feature changed according to the instruction, reexecuting the image processing of the image based on the redetermined image processing condition, and displaying the image to which the image processing was reexecuted.

### BACKGROUND OF THE INVENTION

1. Field of the Invention

The present invention relates to an image processing apparatus useful for correcting an image taken by a digital camera or the like and an image processing method.

2. Description of the Related Art

Conventionally, digital image data is processed by various types of image processing concerning adjustment of saturation, color tone, contrast, and gradation. In the past, such image processing has been performed by operators having expertise. In that case, by making full use of experience and knowledge and checking the processed image on a computer monitor using advanced software, the operators have processed the images while repeating trial and error.

In recent years, however, according to the widespread use of digital cameras, in addition to users who are skilled in the use of analog cameras, camera beginners have started to use digital cameras. Such users do not always have enough knowledge of cameras and may not be able to set appropriate conditions for photography such as exposure time and focusing. Accordingly, if the images are taken under unfavorable conditions, it is useful to perform image processing on such images. However, the photographer does not always have enough knowledge regarding structure of image data and how to process the data.

Under these circumstances, Japanese Patent Application Laid-Open No. 2004-236110 discusses a method by which a photograph of a human figure is automatically corrected based on the detected face by detecting a face from a photographed image.

However, the method discussed in Japanese Patent Application Laid-Open No. 2004-236110 does not always provide a desirable correction. For example, false detection of a face or detection error may occur. Further, if a plurality of detected objects such as faces exist, the object that is used as a reference of correction may be different from the one as intended by the user. Further, since the correction is designed to please a majority of users, the correction may not match the taste of a specific user (e.g., the user prefers bright to dark image, and vice versa). Further, the correction may not match the intention of the photographer at the time the image was taken.

### SUMMARY OF THE INVENTION

The present invention is directed to an image processing method and an image processing apparatus that allow users to obtain an image processing result that reflect users' intention.

According to an aspect of the present invention, an image processing apparatus includes a detecting unit configured to detect a plurality of predetermined image features from an image, a ranking unit configured to perform ranking of the image features, a determination unit configured to determine an image processing condition based on an image feature ranked highest in the ranking, an image processing unit configured to perform image processing on the image based on the image processing condition, an image display unit configured to display an image which was processed by the image processing unit, a receiving unit configured to receive an instruction to change the image feature used in determination of the image processing condition, and a control unit configured to cause the determination unit to redetermine the image processing condition based on an image feature changed according to the instruction, to cause the image processing unit to reexecute the image processing of the image based on the redetermined image processing condition, and to cause the image display unit to display an image to which the image processing was reexecuted.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 illustrates a configuration of an image processing apparatus according to a first exemplary embodiment of the present invention.

FIG. 2 is a flowchart illustrating content of image processing according to the first exemplary embodiment.

FIGS. 3A to 3D illustrate an example of a graphical user interface (GUI) displayed during the image processing according to the first exemplary embodiment.

FIG. 4 illustrates image data displayed in a list.

FIG. 5 is a flowchart illustrating content of image processing according to another example of the first exemplary embodiment.

FIG. 6 illustrates an example of a GUI displayed during the image processing according to a second exemplary embodiment of the present invention.

FIG. 7 illustrate an example of a graphical user interface (GUI) displayed during the image processing according to another example of the second exemplary embodiment.

FIG. 8 illustrates an outline of the Hough transform.

FIG. 9 illustrates loci of a group of straight lines that intersect at three points P, P1 and P2 in FIG. 8 that is obtained by plotting the straight lines on a ρ-ω plane.

FIGS. 10A and 10B illustrate an example of a GUI displayed during the image processing according to a third exemplary embodiment of the present invention.

FIG. 11 is a flowchart illustrating content of image processing according to a fifth exemplary embodiment of the present invention.

### DETAILED DESCRIPTION OF THE EMBODIMENTS

Various exemplary embodiments, features, and aspects of the present invention will now be herein described in detail below with reference to the drawings. It is to be noted that the relative arrangement of the components, the numerical expressions, and numerical values set forth in these embodiments are not intended to limit the scope of the present invention.

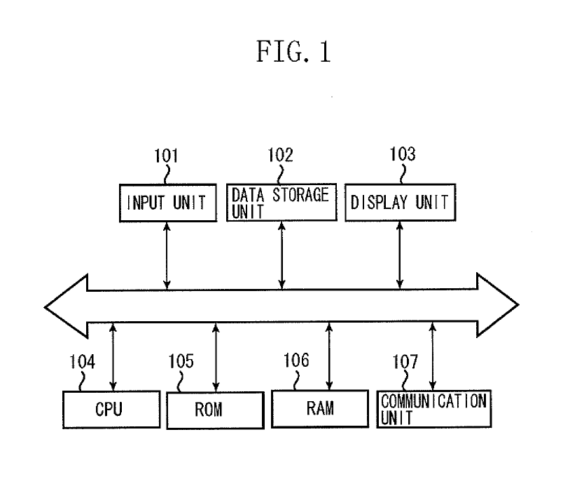

FIG. 1 illustrates a configuration of an image processing apparatus according to a first exemplary embodiment of the present invention.

The image processing apparatus includes an input unit 101, a data storage unit 102, a display unit 103, a central processing unit (CPU) 104, a read-only memory (ROM) 105, a random access memory (RAM) 106 and a communication unit 107, all of which are mutually connected via a bus.

A keyboard and/or a pointing apparatus is used as the input unit 101. A user inputs an instruction and data using the input unit 101. If the image processing apparatus is incorporated into a digital camera, a printer and the like, the pointing apparatus can include a button or a mode dial. Further, the pointing apparatus can include a software-based keyboard.

A hard disk or a memory card is used as the data storage unit 102. Image data is stored in the data storage unit 102. Data other than the image data and a program can also be stored in the data storage unit 102. The data storage unit 102 can be a part of the RAM 106. Further, a data storage unit provided in an external device connected to the image processing apparatus via the communication unit 107 can be used as the data storage unit 102 of the image processing apparatus.

A CRT display or a liquid crystal display is used as the display unit 103. The display unit 103 displays, for example, an image before and after the image processing is performed. Further the display unit 103 can display an image of a graphic user interface (GUI) that allows the user to make necessary inputs for the image processing. Further, a display unit provided on the external device which is connected to the image processing apparatus via the communication unit 107 can also be used as the display unit 103 of the image processing apparatus.

The CPU 104 controls the input unit 101, the data storage unit 102, the display unit 103, the ROM 105, the RAM 106, and the communication unit 107 based on a program, for example, stored in the ROM 105. The ROM 105 and the RAM 106 provides the CPU 104 with a program, data, and a working area necessary for the CPU 104 in performing the processing. This program includes a program concerning image processing, which is described below.

If the program is stored in the data storage unit 102, the CPU 104 temporarily loads the program into the RAM 106 and then executes the program. If the program is stored in the external device that is connected to the image processing apparatus via the communication unit 107, the CPU 104 temporarily stores the program in the data storage unit 102 and then loads it into the RAM 106, or directly loads the program into the RAM 106 via the communication unit 107 and then executes the program.

The communication unit 107 serves as a communication interface between the external device and the image processing apparatus based on either wired or wireless communication.

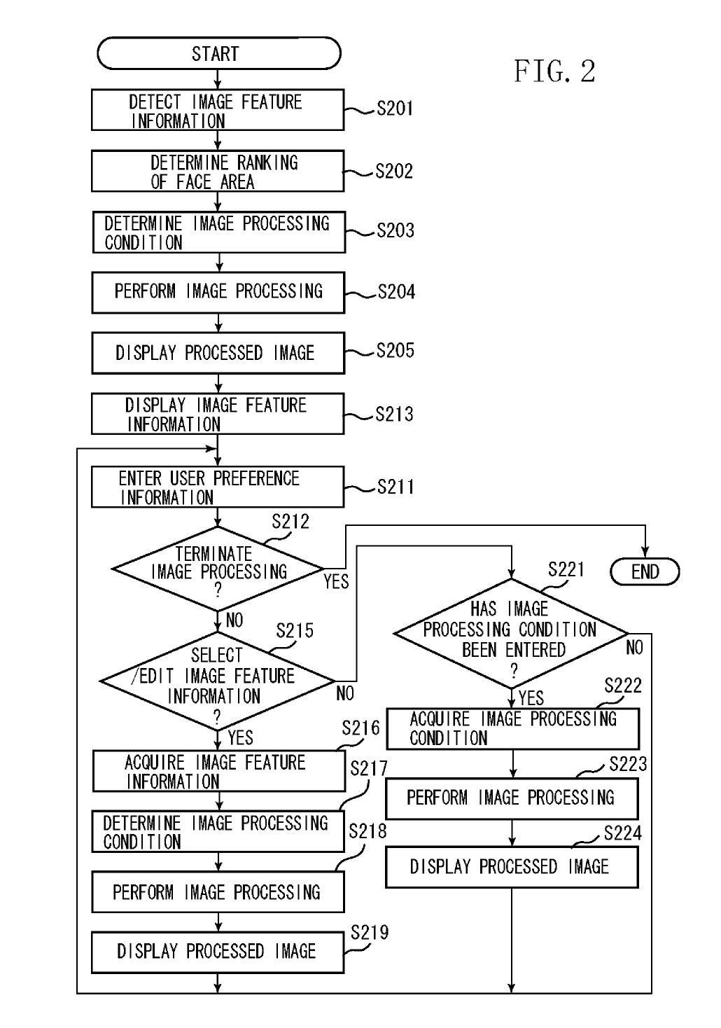

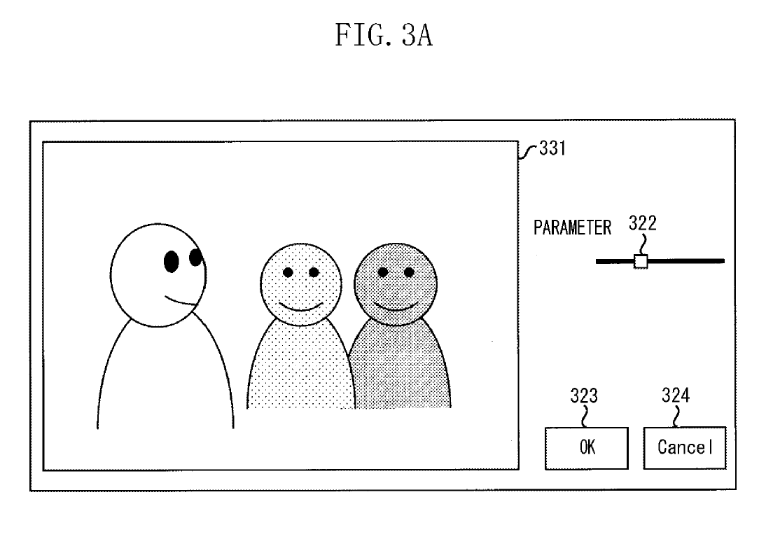

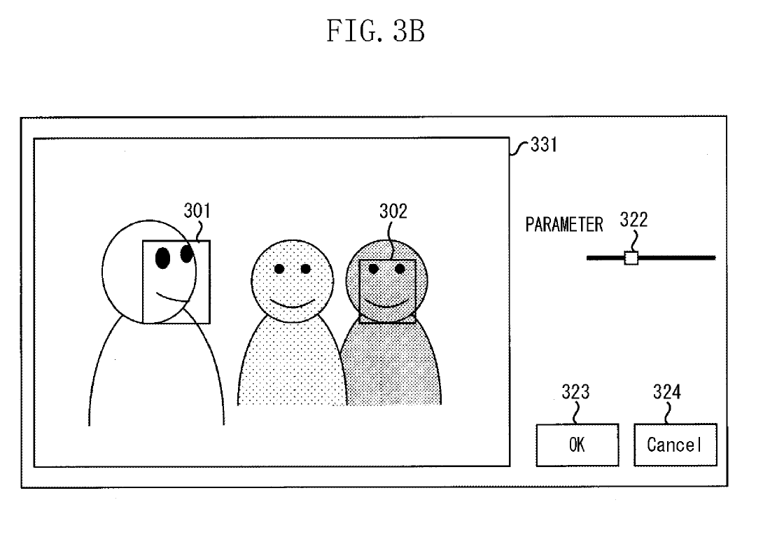

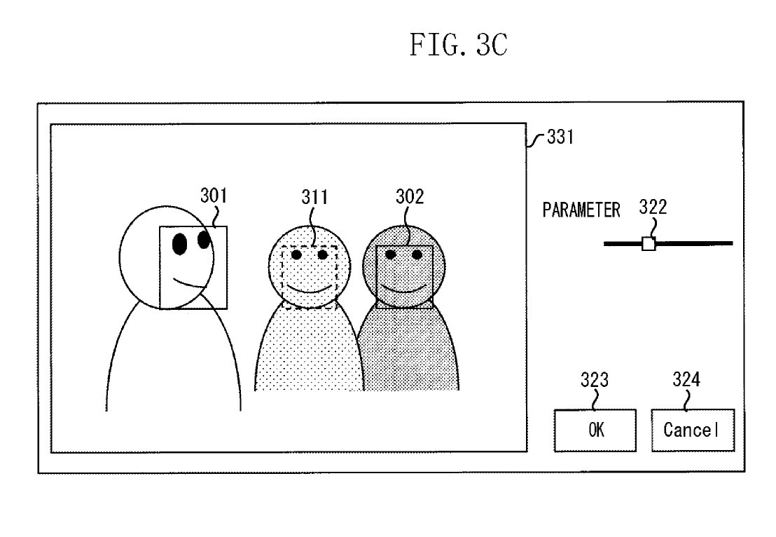

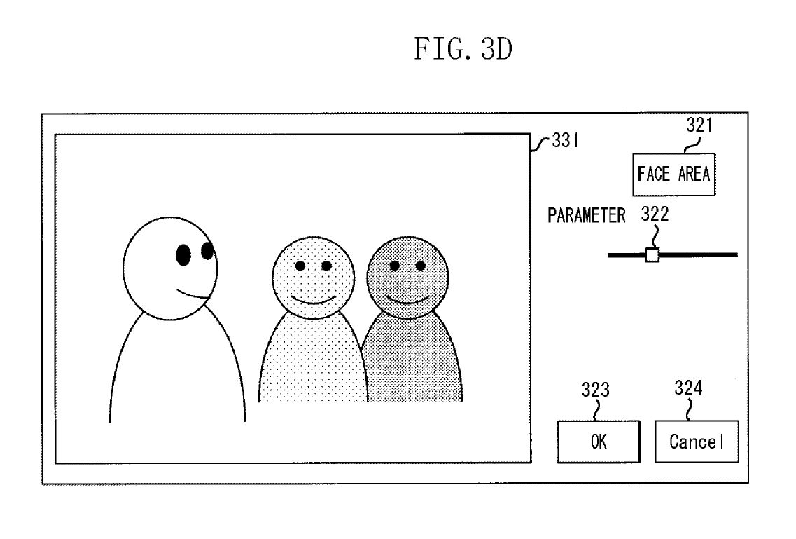

Next, image processing of the image processing apparatus having the above-mentioned configuration will be described. According to this image processing, a human face is taken from an input image as image feature information, and brightness of the image is corrected accordingly. The image processing is executed mainly according to an operation of the CPU 104 based on a program. FIG. 2 is a flowchart illustrating content of image processing according to the first exemplary embodiment. FIGS. 3A to 3C illustrate an example of a GUI displayed during the image processing according to the first exemplary embodiment.

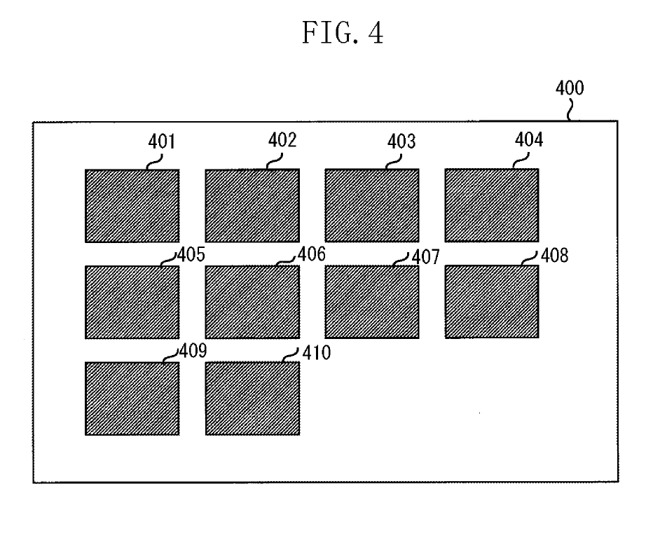

First, the CPU 104 loads the image data to be processed according to an operation of the input unit 101. The image data is stored in, for example, the data storage unit 102 in a predetermined file format. For example, as illustrated in FIG. 4, the CPU 104 displays a list of the image data on the display unit 103. In this state, if an instruction to select one or more images is input from the input unit 101, it triggers the input of the selected image.

FIG. 4 illustrates image data displayed in a list. In FIG. 4, ten thumbnails (thumbnails 401 to 410) are displayed in a display window 400. The thumbnails 401 to 410 correspond to, for example, files of the image data stored in the data storage unit 102.

If the user inputs an instruction and selects an image using the input unit 101, the CPU 104 loads the image data corresponding to the selected image from the data storage unit 102 into the RAM 106 according to a predetermined file format. At this time, if the image data is compressed in a format such as JPEG, the compressed image data is decompressed by a decompression method that corresponds to the compression method. Then, the decompressed data is stored in the RAM 106. Further, if the image data is RAW image, more specifically, if the data is made of signal values of a CCD image sensor or the like, the data goes through pre-process (i.e., development process) before it is stored in the RAM 106.

In step S201, the CPU 104 analyzes the input image data, detects a feature of the image data, and generates image feature information. According to the present exemplary embodiment, one or more human faces in the image data are detected. Then, the image feature information (information about human figure object) that shows the result of the detection is stored in the RAM 106. At that time, the CPU 104 generates coordinate information that determines four vertices of a rectangle as information that indicates a rough position of the detected face for each of the detected faces. The coordinate information is also stored in the RAM 106 as a result of the detection.

Various methods can be employed for the detection of faces. For example, a method discussed in Japanese Patent Application Laid-Open No. 2005-346474 or 2004-199673 can be employed. Further, a face detection method using skin color can be used. If the image data does not include a face or if a face is not detected, the fact is stored in the RAM 106 as a result of the face detection. If, for example, a number of detected faces can be stored in addition to a detection result based on the coordinate information, a case where the image data does not include a face or a case where a face is not detected can be expressed by setting the number of faces to 0. Further, if the detection result is stored in a list format, the above cases can be also realized by storing a list that is empty.

In step S202, the CPU 104 ranks the detected face area according to a predetermined rule. Various rules and ranking methods can be used in this process. If a face detection method discussed in Japanese Patent Application Laid-Open No. 2004-199673 is used, probability that a detected object is a face can be also obtained when an object is detected. Thus, the ranking can be determined according to the probability.

Further, the ranking can be determined according to a size of the face area and/or a location of the face area in the image data. For example, with respect to a plurality of face areas, a larger face area, or a face area that is closer to the center of the image can be ranked higher. The ranking method is discussed, for example, in Japanese Patent Application Laid-Open No. 2004-362443.

The size of the face area and the location of the face area in the image data can be determined according to coordinate information included in the face detection result information. The ranking can be determined by combining the probability that the object is a face and importance based on the size and the location of the face area. For example, the ranking can be determined by multiplying a numerical value indicating the importance by the probability of the object being a face.

Further, it is useful if the CPU 104 not only determines the ranking but sorts the data of the result of the face detection in step S202.

Next, in step S203, the CPU 104 determines the face area that is ranked highest and determines the image processing condition using the detection information about the face area. According to the present exemplary embodiment, the CPU 104 determines a processing parameter of γ correction that is appropriate for adjustment of the brightness of the face area, as an image processing condition. In other words, the CPU 104 calculates representative luminance from a distribution of brightness of the determined face area. Then, the CPU 104 determines the processing parameter of the γ correction so that the representative luminance approximates a predetermined desirable brightness. The processing parameter of the γ correction is thus determined as an image processing condition in adjusting the brightness of the whole image.

When the image processing condition is determined, a pixel value of the corresponding area of the original image that is to be processed can be referred as needed. A method for correcting brightness of an image according to a result of face detection and a method for determining a processing parameter are discussed in Japanese Patent Application Laid-Open Nos. 2004-236110 and 2004-362443.

In step S204, the CPU 104 performs image processing of the input image data according to the image processing condition (processing parameter) determined in step S203 and obtains the result. According to the present exemplary embodiment, since the brightness is adjusted by the γ correction as described above, the RGB values of each pixel of the image data to be processed will be converted into YCbCr values according to the equation (1) below.

$$( \begin{matrix}Y \\ Cb \\ Cr\end{matrix} ) = ( \begin{matrix}0.2990 & 0.5870 & 0.1140 \\ - 0.1687 & - 0.3313 & 0.5000 \\ 0.5000 & - 0.4187 & - 0.0813\end{matrix} ) ( \begin{matrix}R \\ G \\ B\end{matrix} ) \qquad ( 1 )$$

Further, the CPU 104 converts the Y value of the obtained YCbCr values according to the equation (2) below. In the equation (2), γ0 is a control parameter of the γ correction. This value is determined in step S203.

$${Y}^{′} = {( \frac{Y}{255} )}^{γ 0} \qquad ( 2 )$$

The CPU 104 further obtains corrected RGB values by inverse conversion of YCbCr values into RGB values according to the equation (3) below.

$$( \begin{matrix}R \\ G \\ B\end{matrix} ) = ( \begin{matrix}1.0000 & 0.0000 & 1.4020 \\ 1.0000 & - 0.3441 & - 0.7141 \\ 1.0000 & 1.7720 & 0.0000\end{matrix} ) ( \begin{matrix}Y \\ Cb \\ Cr\end{matrix} ) \qquad ( 3 )$$

While the RGB values and the YCbCr values of the above equations are expressed in 8 bit integers, more specifically, the RGB and Y values are in the range of 0 to 255 and the CbCr values are in the range of −128 to 127, each signal value may be expressed in 16 bit integers. Further, the RGB values and the YCbCr values can be expressed in normalized real numbers of 0 to 1.0. In these cases, a maximum value of Y is substituted for the denominator of the right side member of the equation (2), that is, “255”. In other words, if the signal value is expressed in 16 bit integers, “65535” is substituted for the denominator of the right side member of the equation (2). Further, if the signal value is expressed in normalized real numbers of 0 to 1.0, “1.0” is substituted for the denominator of the right side member of the equation (2).

In step S205, the CPU 104 displays the result of the image processing performed in step S204 on the display unit 103. For example, as illustrated in FIG. 3A, the image processed in step S204 is displayed in a display area 331.

If the image feature information is not detected in step S201, steps S202 to 204 are skipped. In step S205, the CPU 104 displays the image of the image data input before step S201, on the display unit 103. Further, by correction processing such as publicly known histogram equalization that does not depend on image feature information, the result of the processing can be displayed on the display unit 103 in step S205.

In step S213, the CPU 104 displays a rectangular frame that represents a face area in the image feature information detected in step S201. The image with the rectangular frame is displayed on the display unit 103 as illustrated in FIG. 3B. Since rectangular frames 301 and 302 are superposed on the image in the display area 331, the user can understand which area has been detected as the face area.

At this time, the CPU 104 also displays an OK button 323 and a cancel button 324. The user presses the OK button 323 if the user thinks that the display result on the display area 331 is favorable and presses the cancel button 324 if not. Further, a slider 322, which is used for adjusting the processing parameter of the γ correction, is also displayed. The slider 322 is displayed in such a manner that the user can change the image processing condition (processing parameter), which was performed on the image displayed on the display area 331.

If the inner areas of the rectangular frames 301 and 302 and their vicinity are specified, the CPU 104 determines that the face areas represented by the rectangular frames 301 and 302 are selected. Further, the user can specify a part of the display area 331 by adding a rectangular frame 311 that represents the specified area to the display area 331 as illustrated in FIG. 3C, and the CPU 104 determines that the area indicated by the rectangular frame 311 is selected as described below. The CPU 104 treats the added rectangular frame 311 in away it treats the rectangular frames 301 and 302. For example, if the rectangular frame 311 is added, the CPU 104 can select the rectangular frame 311. Processing concerning selection of an area surrounded by a rectangular frame will be described below.

If, in step S202, the face area represented by the rectangular frame 301 is at the top of the ranking and the face area represented by the rectangular frame 302 is at the second place, then, in step S203, the CPU 104 determines the processing parameter of the γ correction based on the detection information of the face area in the rectangular frame 301 and, in step S204, executes the image processing using the processing parameter.

The displaying method of the image feature information is not limited to the aforementioned method. For example, without displaying a rectangular frame, coordinate values that represent a face area can be expressed by using a list box, and the information can be displayed using character information. Further, the shape that represents the selected face area is not limited to a rectangle, and a circle or an ellipse can also be used. Furthermore, it is useful if its thickness or color can be changed so that it will be easier for the user to distinguish the frame line from the object in the image.

Further, in step S213, the CPU 104 does not necessarily display all of the face areas detected in step S201. However, it is useful if at least the face areas used in determining the image processing condition of the most recent image processing are displayed. Ten or more faces may be included in the image depending on image data. If rectangular frames of all of such faces are displayed, information useful to the user will mix with useless information.

In such a case, according to the rank determined in step S202, face areas that are ranked highest up to n-th in the ranking (n is a predetermined natural number) are displayed. Further, a threshold can be set in advance for a value that is used in determining the ranking (e.g., probability that the object is a face and importance based on size and location of the face area). Then, only a face area having a value that exceeds the threshold value is displayed.

If a display as illustrated in FIG. 3B is displayed as a result of the processing in step S213, in step S211, the user can incorporate his preferences into the image processing apparatus. In other words, the user can determine and express his intention whether the result illustrated in FIG. 3B is favorable, the result needs correction, or the processing is to be ended without performing the image processing

When indicating his intention, the user presses the OK button 323 if the processing result is favorable. If the processing result is not favorable due to, for example, image specification error, the user presses the cancel button 324. Further, if correction is necessary, the user makes necessary correction by selecting the area represented by the rectangular frame, adding a new rectangular frame, or operating the slider 322. The operation necessary in correcting the image processing will be described below.

In step S212, the CPU 104 determines whether the OK button 323 or the cancel button 324 is pressed. More specifically, the CPU 104 determines whether the user has indicated his intention to terminate the operation. The operation ends normally if the OK button 323 is pressed. The operation is cancelled if the cancel button 324 is pressed. The intention of the user is determined by coordinate information specified by the user using a mouse or the like.

If the termination of the operation is not expressed, and the operation necessary in correcting the image processing is performed (NO in step S212), the process proceeds to step S215. In step S215, the CPU 104 determines whether the operation relates to selecting and/or editing (i.e., changing) the image feature information. According to the present exemplary embodiment, such operation means selecting and adding a rectangular frame that represents the face area. In other words, the CPU 104 determines whether any of the rectangular frames in the display area 331 is selected or a rectangular frame is added to the display area 331. At this time, the face area that has been used as a reference in the most recent image processing can be ignored.

If the CPU 104 determines that the operation relates to selecting and/or editing the image feature information (YES in step S215), then the process proceeds to step S216. In step S216, the CPU 104 acquires the image feature information of the face area that corresponds to the selected rectangular frame from the RAM 106. If a rectangular frame is to be added, since the image feature information is not acquired at the time the rectangular frame is to be added, the image feature information is extracted and acquired after the rectangular frame 311 is added as illustrated in FIG. 3C, according to a process similar to that in step S201.

In step S217, the CPU 104 determines the image processing condition from the image feature information acquired in step S216 according to a process similar to the one in step S203. In other words, the CPU 104 changes the processing parameter of the γ correction that is the image processing condition based on the image feature information acquired in step S216.

In step S218, the CPU 104, performs image processing of the input image data by a process similar to the one in step S204 according to the image processing condition (processing parameter) determined in step S217 and acquires the result. More particularly, the CPU 104 executes the γ correction.

In step S219, the CPU 104 displays the result of the process in step S218 on the display unit 103 according to a process similar to the one in step S205. After then, the process returns to step S211 and the CPU 104 waits until an instruction from the user is entered.

Next, a case will be described where the operation in step S215 is determined as not relating to selecting and/or editing the image feature information.

According to the present exemplary embodiment, the operation that does not relate to selecting and/or editing the image feature information in step S215 is an operation of the slider 322. In step S215, if the operation is determined as not relating to selecting and/or editing the image feature information (NO in step S215), then the process proceeds to step S221. In step S221, the CPU 104 determines whether the operation relates to the operation of the slider 322 for inputting an image processing condition (processing parameter).

If the operation relates to the operation of the slider 322 (YES in step S221), then the process proceeds to step S222. In step S222, the CPU 104 acquires the image processing condition that is set by the slider 322 as a processing parameter based on a state of the slider 322.

In step S223, the CPU 104, performs image processing of the input image data by a process similar to the one in step S204 according to the image processing condition (processing parameter) acquired in step S222 and obtains the result. More particularly, the CPU 104 executes the γ correction.

In step S224, the CPU 104 displays the result of the process in step S223 on the display unit 103 according to a process similar to the one in step S205. After then, the process returns to step S211 and the CPU 104 waits until an instruction from the user is entered.

In step S221, if the CPU 104 determines that the operation is not an operation of the slider 322 (NO in step S221), then the process returns to step S211 and the CPU 104 waits until an instruction from the user is entered. If it is not determined whether the operation is an operation of the slider 322, the process in step S221 can be omitted.

Further, in step S212, if the OK button 323 (normal termination) or the cancel button 324 (termination by cancellation) is pressed, the CPU 104 terminates the image processing. If the OK button 323 is pressed, the CPU 104 stores a latest result of the image processing that has been performed in the data storage unit 102 in a predetermined format (image data storage processing), or sends a latest result of the image processing to an external device (e.g., a printer) via the communication unit 107.

Furthermore, the CPU 104 can change the GUI, display the changed GUI on the display unit 103, store the image in the data storage unit 102 according to the instruction given by the user, and transmit the image via the communication unit 107. On the other hand, in step S212, if the cancel button 324 is pressed (YES in step S212), the CPU 104 discards the result of the image processing.

In this way, the processes are performed.

Next, a relation between indication of intention of the user in step S211 and image processing will be described based on an assumption that the face area represented by the rectangular frame 301 is ranked the first and the face area represented by the rectangular frame 302 is ranked the second in step S202 as described above. Thus, the processing parameter of the γ correction based on the detection information of the face area represented by the rectangular frame 301 is determined in step S203, and the image processing using the processing parameter is performed in step S204. Further, the description below is based on an assumption that with respect to the image data when it is input, the human face on the left side in the rectangular frame 301 in FIGS. 3A to 3C is bright and appropriately photographed while the human face at the center in the rectangular frame 311 is dark, and the human face on the right side in the rectangular frame 302 is still darker.

If the processes in step S201 to S204 are performed under such conditions, since the human face on the left side is appropriately bright from the beginning, the brightness of the whole image will not change as compared to the initial state. Thus, the human faces at the center and on the right displayed in steps S205 and S213 will remain dark.

If the user considers that the figure on the left side is the main object, the user can press the OK button 323. However, there is a case where the figure at the center or on the right side is the main object and the figure on the left side is a person who just happened to be passing by. In such a case, it is useful to perform image processing based on the figure at the center or on the right side. In other words, it would be desirable for the user if the figure at the center or on the right side becomes brighter.

In such a case, the user can, for example, specify an area in the rectangular frame 302 that represents the human face on the right side or an area in the vicinity of the rectangular frame 302. Then, the CPU 104 performs the processes in steps S216 to S219 after the determination in step S212 and step S215 is made, referring to the brightness of the human face on the right side. Thus, an image that is brightly corrected, just as if the exposure has been adjusted to the human face on the right side, will be displayed on the display area 331.

Further, the user can add the rectangular frame 311 that represents the human face at the center. Then, the CPU 104 performs the processes in steps S216 to S219 after the determination in steps S212 and S215 is made, referring to the brightness of the human face at the center. Consequently, an image that is brightly corrected just as if the exposure has been adjusted to the human face at the center will be displayed on the display area 331.

Furthermore, the specification of the rectangular frame 302 that represents the human face on the right side and the specification of the rectangular frame 311 that represents the human face at the center can be combined. In other words, after either of the two rectangular frames is specified, if the obtained result is not favorable, the other frame can be specified. For example, after performing image processing concerning the specification of the rectangular frame 302 that represents the human face on the right side, if the user feels that the human face at the center is brighter than required, then processing of the rectangular frame 311 that represents the human face at the center can be added.

Further, the user can specify the processing parameter of the γ correction without determining the face area that is used as a reference. In that case, the user operates the slider 322 using the input unit 101. Then, after the determination in steps S212 and S215 is made, in step 222, the CPU 104 acquires the processing parameter which the user specified. Based on the acquired processing parameter, the CPU 104 performs the processes in steps S223 to S224. As a result, an image that is processed using the specified processing parameter is displayed on the display area 331, and the user can adjust the image processing condition (the parameter of the γ correction) while viewing the image displayed on the display area 331.

While a rectangular frame is added in specifying an area in the above description, a new area can also be specified by moving the rectangular frame 301 or 302. Further, the size of the rectangular frame may be changeable. In other words, the rectangular frame area can be changed according to various methods.

According to the first exemplary embodiment, the face detection is performed based on input image data and the ranking is performed based on the result of the detection. Further, brightness is automatically adjusted according to the result of the detection concerning the image of the highest rank. Furthermore, processing is performed based on an instruction that is given by the user considering the result of the face detection and further, processing is performed according to the parameter specification used for adjusting brightness.

The processes are arranged so that the processing can be performed seamlessly. Thus, the user can reduce operation required in obtaining a desirable brightness-adjusted image. More specifically, if a favorable result can be obtained by the first automatic processing, then substantially no additional workload is required. Even if a favorable result cannot be obtained by the first automatic processing, a corrected result can be obtained by semiautomatic correction processing including simple selection while the user confirms the processing. On the other hand, even if the user is not satisfied with the automatic and the semiautomatic correction processing, since the processing parameter can be changed, an appropriate correction result can be obtained.

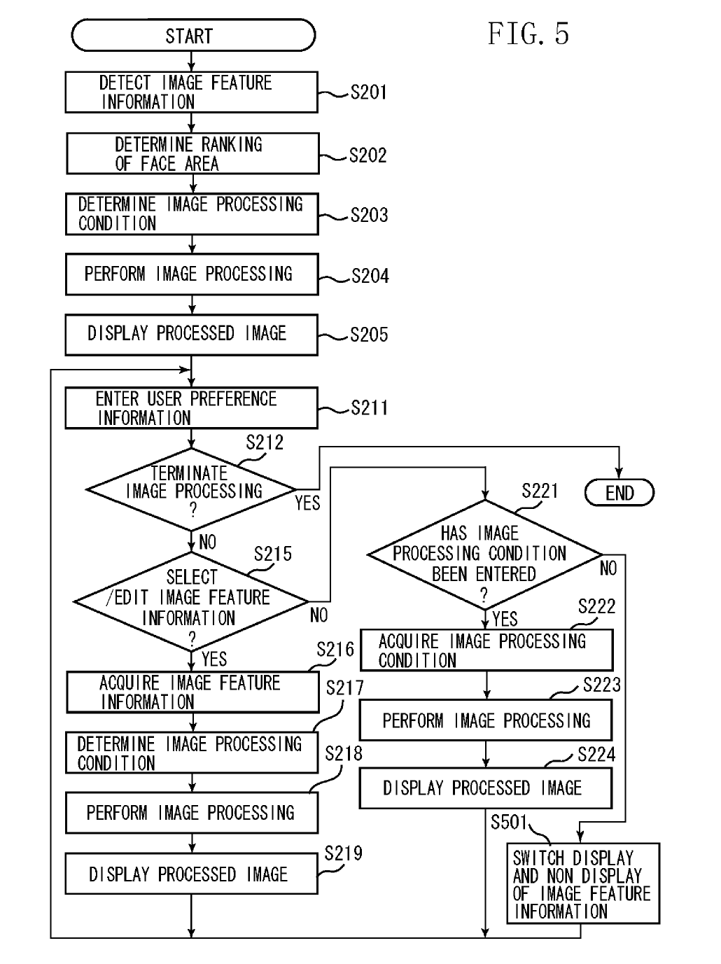

According to the first exemplary embodiment, although a rectangular frame is unconditionally displayed after step S205, as illustrated in FIG. 3D, a face area button 321 as an interface can be displayed on the display unit 103, and display/non-display of the image feature information can be changed according to the operation of the button. FIG. 5 is a flowchart illustrating processes when such a configuration is employed.

As illustrated in FIG. 5, the process in step S213 in FIG. 2 is omitted from the flowchart. Further, in step S221, if the CPU 104 determines that the input is not related to image processing condition (NO in step S221), then the process proceeds to step S501. In step S501, the CPU 104 determines that the operation is based on operation of the face area button 321, and changes the display/non-display of the image feature information represented by a rectangular frame. In other words, if image feature information represented by a frame is not being displayed, then image feature information will be displayed. If image feature information represented by a frame is being displayed, then the image feature information will be not be displayed. Other processes are similar to those illustrated in FIG. 2.

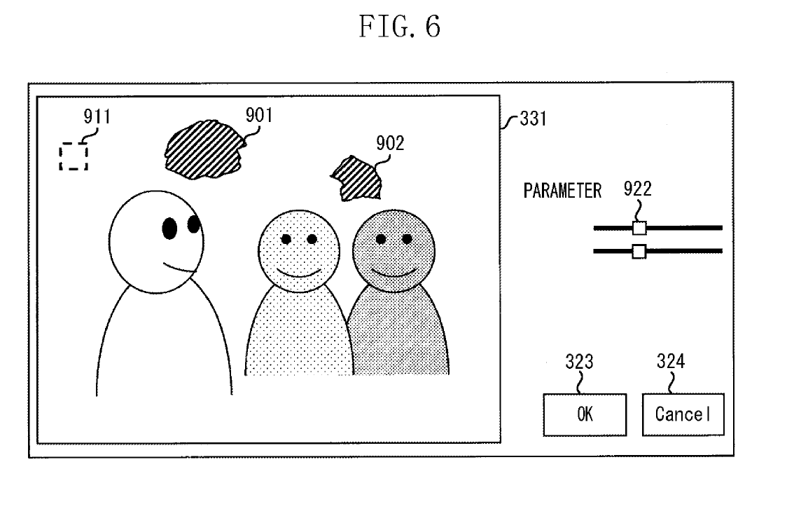

Next, a second exemplary embodiment of the present invention will be described. According to the first exemplary embodiment, face detection is performed as a source of image feature information and γ correction is performed based on the brightness of the face area. According to the second exemplary embodiment, detection of a white area is performed as a source of image feature information and white balance processing is performed based on a representative color. In other words, an image area that includes one or more pixels and that is assumed to be actually white is detected, and then color balance adjustment such as white balance adjustment is performed. As the image processing, tint is adjusted. Other configurations are similar to those of the first exemplary embodiment. FIG. 6 illustrates an example of a GUI displayed during the image processing according to the second exemplary embodiment.

According to the present exemplary embodiment, in step S201, the CPU 104 divides the input image data into a plurality of areas. The dividing of the image data can be performed by any method. According to the present exemplary embodiment, however, pixels having similar colors in an image are collected and classified. This method is discussed in Japanese Patent Application Laid-Open No. 2001-043371.

In step S202, the CPU 104 evaluates each area that is divided and ranks each area. According to the present exemplary embodiment, the ranking is based on whiteness of the area. In evaluating whiteness, the CPU 104 determines a representative color in the area. In determining the representative color, the CPU 104 acquires, for example, a mean value, a mode value, or a median value of each pixel value in the area.

Normally, a color is defined by a plurality of channels. In the RGB color space, for example, image data is defined by three channels R, G, and B. In such a case, a median value is obtained for each channel and the obtained median values are regarded as the median values of the color. After determining a representative color, the CPU 104 evaluates a closeness of the representative color to white. According to this evaluation, the representative color is converted into a color space that represents brightness, hue, and saturation. Then, a distance between the brightness axis and the representative color is obtained. It is evaluated that the smaller the distance is, the closer to white the representative color is.

Regarding color spaces that represent brightness, hue, and saturation, CIE L*a*b*, YCbCr, HSV, and HLS are known color spaces. According to the present exemplary embodiment, representative color in RGB is converted into YCbCr according to the equation (1), a distance indicating closeness to white is defined as saturation, and saturation D is obtained according to the following equation (4).

D=Cb²+Cr² (4)

Then, each area is ranked in ascending order of saturation D.

In step S203, the CPU 104 determines an area that is ranked highest and determines the image processing condition using detection information (representative color) of the area. According to the present exemplary embodiment, the CPU 104 determines as the image processing condition a white balance parameter of white balance processing performed on the determined area. In determining the parameter of the white balance processing, the CPU 104 acquires such a parameter that when the RGB values of a representative color in the reference area are input, RGB values of R=G=B are obtained after conversion.

As described below, according to the present exemplary embodiment, the white balance processing is started by obtaining ratios of R and D channel data to G channel data of a representative color. Then, reciprocal of the ratios are obtained as gain values of R and B channel data. After then, white balance processing is performed by applying the obtained gain values to all pixels of the input image. Thus, in step S203, the CPU 104 acquires the R gain corresponding to a gain value of the R channel data and B gain corresponding to a gain value of the B channel data according to the following equation (5).

$${R}_{gain} = \frac{G}{R} \\ {B}_{gain} = \frac{G}{B} \qquad ( 5 )$$

According to the equation (5), R, G, and B represent the R channel value, the G channel value, and the B channel value of a representative color of each area respectively. According to the present exemplary embodiment, the R gain and the B gain are used as image processing conditions (white balance parameters) in the processing described below.

In step S204, the CPU 104 performs image processing of the input image data according to the image processing condition (white balance parameter) determined in step S203 and obtains the result. According to the present exemplary embodiment, white balance processing is performed, as described above, by multiplying R data and B data of each pixel of the input image by R gain and B gain. Further, the CPU 104 performs the image processing in steps S218 and S223 in a similar manner.

Then, after step S213, for example, an image that is illustrated in FIG. 6 will be displayed. According to the present exemplary embodiment, in place of a rectangular frame that represents a face area, frames 901 and 902 that represent the detected area are displayed in the display area 331 as illustrated in FIG. 6. Further, a slider group 922 including two sliders is displayed according to the present exemplary embodiment. This is because two parameters (R gain and B gain) are used in the white balance processing. Furthermore, similar to the first exemplary embodiment, the user can add a rectangular frame 911 which is used as a reference for the white balance processing.

According to the second exemplary embodiment, an effect similar to that obtained in the first exemplary embodiment can be obtained.

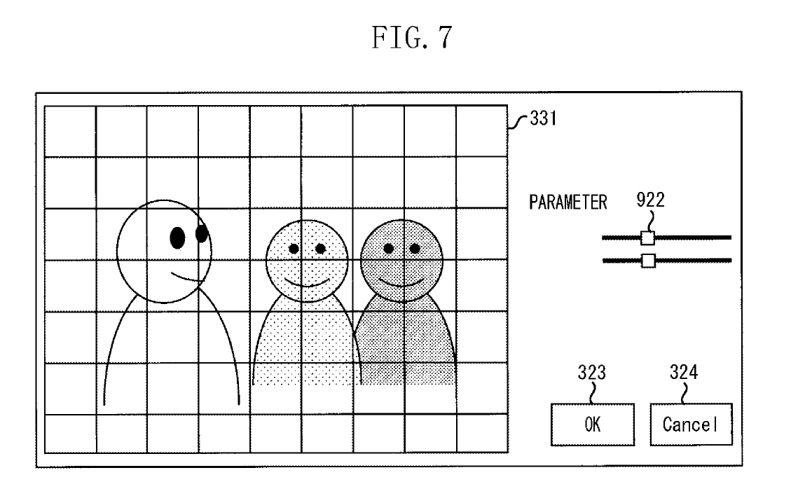

In dividing the area in step S201, as illustrated in FIG. 7, the input image data can be simply divided into rectangular areas. For example, the image data can be divided into a plurality of rectangular areas each having a predetermined size, or the image data can be divided into a predetermined number of areas having a substantially same size.

Further, the processes in the flowchart illustrated in FIG. 5 can also be applied to the second exemplary embodiment.

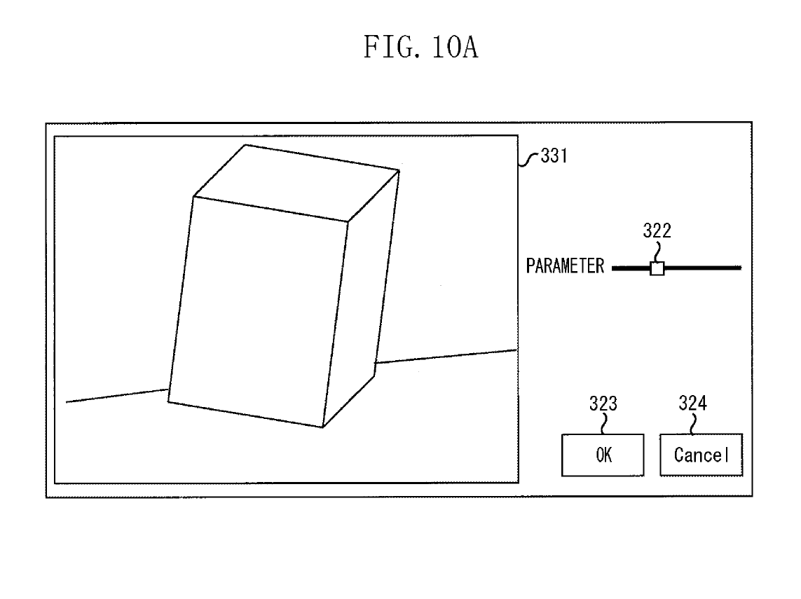

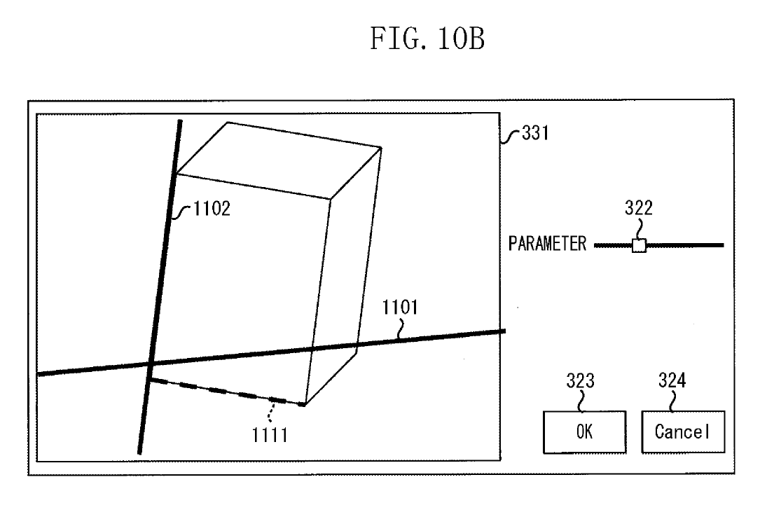

Next, a third embodiment of the present invention will be described. As the image processing, the γ correction is performed in the first exemplary embodiment and the white balance processing is performed in the second exemplary embodiment. According to the third embodiment, a straight line component (line segment) is used as the image feature information and the image is rotated based on the direction of the straight line component. Other configurations are similar to those of the first exemplary embodiment. FIGS. 10A and 10B illustrate an example of a GUI displayed during the image processing according to a third exemplary embodiment.

According to the present exemplary embodiment, in step S201, the CPU 104 extracts a straight line component from the input image data. Any extraction method of the straight line component can be employed. For example, according to the present exemplary embodiment, the straight line component is extracted by obtaining a luminance image according to calculation of a luminance value of each pixel value of the pixels included in the input image data. An edge image is generated by extracting an edge component from the obtained luminance image, and Hough transform is applied to the generated edge image.

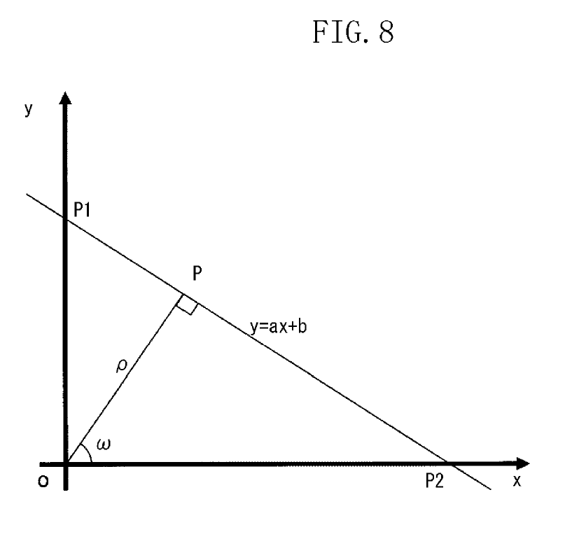

Now, Hough transform will be briefly described. FIG. 8 illustrates an outline of the Hough transform using an X-Y coordinate system. In FIG. 8, a straight line y=ax+b and a straight line OP are orthogonal to each other and crosses at a point P. An angle between the straight line OP and the X axis is defined as A, and a length of the straight line OP is defined as p. If X and p are determined, a straight line y=ax+b will be uniquely defined. Based on this relation, a point (ρ,ω) represents the straight line y=ax+b in Hough transform.

Further, a group of straight lines having different slope angles that cross at a point (x0,y0) in the X-Y coordinate system is expressed by the following equation (6).

ρ=x cos ω+y sin ω (6)

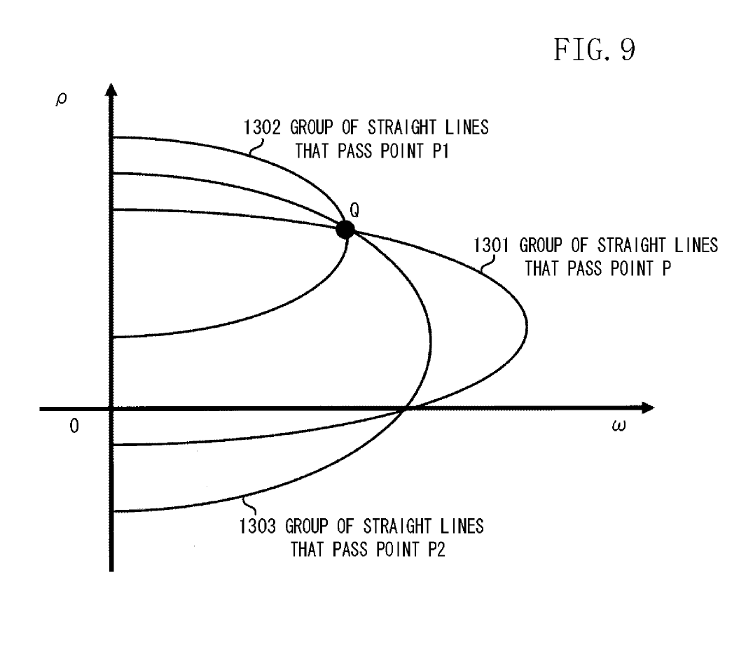

If loci of a group of straight lines that cross the three points P, P1 and P2 in FIG. 8 are plotted on the ρ-ω plane, a result, for example, illustrated in FIG. 9 is obtained.

In FIG. 9, a curve 1301 is a locus of a group of straight lines that pass the point P on the ρ-ω plane in FIG. 8. A curve 1302 is a locus of a group of straight lines that pass the point P1 on the ρ-ω plane in FIG. 8. A curve 1303 is a locus of a group of straight lines that pass the point P2 on the ρ-ω plane in FIG. 8. As is clear from FIG. 9, the loci of the groups of straight lines that pass the points on the same line on the x-y plane cross at one point (point Q in FIG. 9) on the ρ-ω plane. Thus, if the point Q on the ρ-ω plane is inversely transformed, then the original straight line can be obtained.

Thus, loci on the ρ-ω plane of the edge pixel of the edge image that has been obtained in advance is obtained by changing ω of the equation (6), and an intersection point of the loci is obtained. Actually, since a straight line is determined by two points in an image, it is useful to extract an intersection point of at least three loci on the ρ-ω plane. In this way, a straight line component can be detected.

In step S202, the CPU 104 evaluates and ranks each straight line component that is detected. According to the present exemplary embodiment, a length of a straight line component (line segment) is obtained by examining an edge pixel on the determined straight line component. Then, the components are ranked in decreasing order of length. The ranking may also be in descending order of a number of loci that intersect at a point on the ρ-ω plane, or in order of increasing angle from 0 degree or 90 degrees.

In step S203, the CPU 104 determines a straight line component that is ranked highest, and determines the image processing condition using the detected information (slope of the straight line component) of the straight line component. According to the present exemplary embodiment, the CPU 104 determines an angle of the rotation processing as the image processing condition.

In step S204, the CPU 104 performs image processing of the input image data according to the image processing condition (rotation angle) determined in step S203, and obtains the result. In other words, rotation processing of the input image data is performed so that the straight line portion selected as a reference of image processing target is horizontal or vertical.

Whether the image processing is performed based on a horizontal or a vertical straight line portion can be determined in advance. However, it is useful to determine whether the straight line portion is close to a horizontal or vertical line from the slope of the straight line component, and rotate the image data depending on whether the straight line portion is closer to horizontal or vertical. Further, the selection can be made according to whether the image is portrait or landscape. The CPU 104 performs the image processing in steps S218 and S223 in a similar manner.

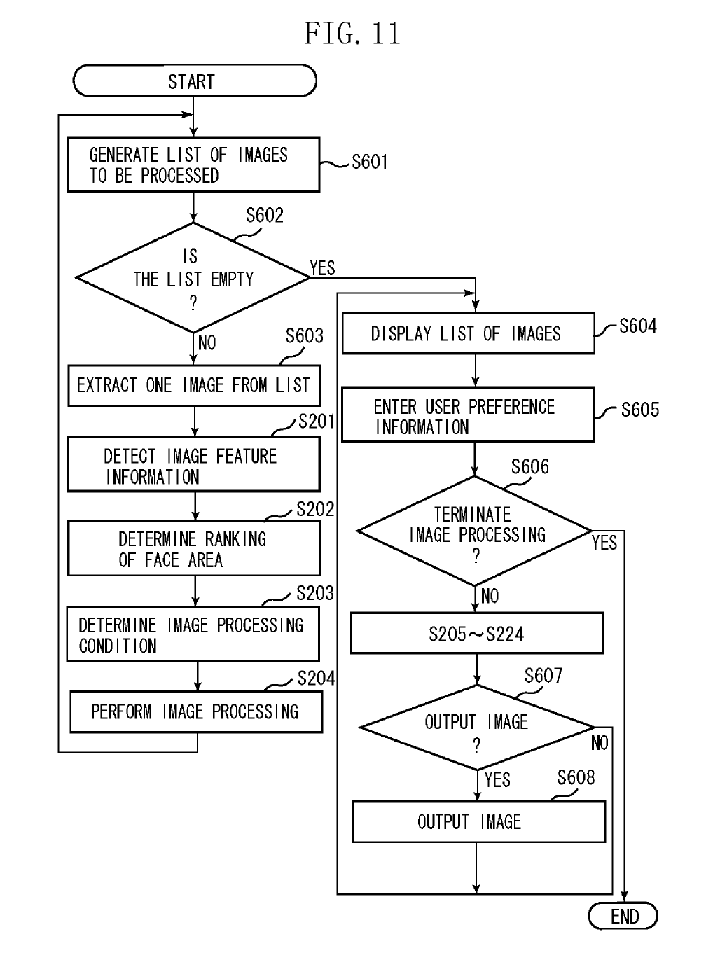

Then, after step S205, S219 or S224, for example, an illustration such as the one in FIG. 11A is displayed. After step S213, an illustration such as the one in FIG. 10B is displayed.

According to the present exemplary embodiment, in place of a rectangular frame that represents a face area, highlighted straight lines 1101 and 1102 that represent the extracted straight line components are displayed in the display area 331 as illustrated in FIG. 10B. According to the present exemplary embodiment, the slider 322 that is used for adjusting the rotation angle of the straight line component is displayed. Further, similar to the first exemplary embodiment, the user can add a straight line component 1111 as a reference straight line component for the rotation processing. The user can add the straight line component by specifying two points in the display area 331 using the input unit 101.

According to the third exemplary embodiment, an effect similar to that obtained in the first exemplary embodiment can be obtained.

The processing illustrated in the flowchart in FIG. 5 can be applied to the third exemplary embodiment.

Next, a fourth exemplary embodiment will be described. According to the fourth exemplary embodiment, image processing is performed according to a scene type.

According to the present exemplary embodiment, in step S201, the CPU 104 determines a main object in the input image data and detects a candidate scene. Various methods can be employed in determining the main object and detecting the candidate scene. For example, the input image data is divided into rectangular blocks and a human figure and the sky are determined as main objects based on a color and a location of each block. Then, the candidate scene is detected. If the input image includes a large sky portion, an outdoor scene is detected as the candidate. If the input image is dark, a night view is detected as the candidate. If the input image includes a skin color area, a scene including a human figure is detected as the candidate. This detection method is discussed in Japanese Patent Application Laid-Open No. 2005-295490.

In step S202, the CPU 104 evaluates each of the detected candidate scenes and ranks each of them. In ranking the candidate scenes, for example, the CPU 104 ranks the candidate scenes in order of descending number of regions or an area (number of pixels) that matches a rule about block color and location which are used for determining the object.

In step S203, the CPU 104 determines a candidate scene that is ranked highest and determines a condition that is set in advance for that scene as the image processing condition. Such a condition is, for example, a high contrast for a landscape image or a small correction amount for an image including a human figure. The condition is set in advance so that the correction processing can be adjusted based on the detected candidate scene as in a case of Exif (exchangeable image file format) Print.

In step S204, the CPU 104 performs image processing of the input image data according to the image processing condition determined in step S203 and obtains the result. Further, the CPU 104 performs image processing in steps S218 and S223 in a similar manner.

Further, a button by which the user can select the candidate scene is displayed as a GUI on the display unit 103 in place of the rectangular frame. If such a GUI is displayed, even if the result of the ranking does not satisfy the user, the user can select a candidate scene. Further, the slider described in the first to the third exemplary embodiments can be displayed. Then, the user can make adjustment using the slider.

According to the fourth exemplary embodiment, an effect similar to that obtained in the first exemplary embodiment can be obtained.

The candidate scene can be set for each object that has been detected. Further, a combination of detected objects (e.g., a combination of a human figure and the sky or a combination of the sky and the sea) can be set as the candidate scene of the image feature information.

Further, the processes of the flowchart illustrated in FIG. 5 can be applied to the fourth exemplary embodiment.

Further, according to the aforementioned exemplary embodiments, when an instruction to select an image is input using the input unit 101, it triggers the processes of the flowchart illustrated in FIG. 2 or 5. A different condition, however, can also trigger such processes. For example, if an instruction to start processing is input using the input unit 101, it can trigger sequential execution of the processes of the flowchart illustrated in FIG. 2 or 5 with respect to the image stored in a predetermined area of the data storage unit 102.

In other words, input of an instruction to start processing can trigger sequential image processing of all the images displayed in FIG. 4. Further, if the CPU 104 acquires image data from an external device via the communication unit 107, the acquisition of the image data can trigger the processes of the flowchart illustrated in FIG. 2 or 5.

Next, a fifth embodiment of the present invention will be described. According to the fifth exemplary embodiment, processes in steps S201 to S204 are performed for all images stored in a predetermined area of the data storage unit 102. After then, image processing that reflects the user's preferences is performed for an image that is selected. FIG. 11 is a flowchart illustrating image processing according to the fifth exemplary embodiment.

According to the present exemplary embodiment, in step S601, the CPU 104 generates a list of images to be processed. The list of the images includes an identifier of each image (e.g. a file name of an image data file). The images to be processed are stored in a predetermined area of the data storage unit 102. The predetermined area can be the whole or a part of the data storage unit 102.

For example, if the image data stored in the data storage unit 102 is classified into a plurality of groups according to directory, then only images in a determined directory or a group can be regarded as images to be processed and an image list of the images to be processed can be generated. Further, the user can select images to be processed in advance. Then if the user enters an instruction using the input unit 101, a list of the selected images can be generated.

Next, in step S602, the CPU 104 determines whether an image to be processed remains on the image list. If the list is empty (YES in step S602), then the process proceeds to step S604. On the other hand, if an image still remains on the image list (NO in step S602), then the process proceeds to step S603. In step S603, the CPU 104 selects one image from the image list and deletes the identifier of that image from the image list.

After then, the CPU 104 executes the processes performed in step S201 to S204 with respect to the selected image similar to the first exemplary embodiment. After step S204, the process returns to step S602.

In step S602, if the image list is empty (YES in step S602), the process proceeds to step S604. In step S604, the CPU 104 displays the images that are processed in step S204 or a magnification-varied image (e.g., thumbnail) of such images in a list arranged as in FIG. 4.

In step S605, the CPU 104 accepts an instruction to select a listed image or terminate display of the listed image. In step S606, the CPU 104 determines whether the instruction sent from the input unit 101 is an instruction to terminate display of the listed image.

If an image in the list is selected (NO in step S606), then the process proceeds to step S205 to S224 and the CPU 104 performs processing similar to that performed in the first exemplary embodiment. If the OK button 323 or the cancel button 324 is pressed in step S212, then the process in step S607 will be performed before the process ends.

In step S607, the CPU 104 determines whether the image is to be output. If the OK button 323 is pressed in step S211 (YES in step S607), then the CPU 104 determines that the image is to be output and the process proceeds to step S608. If the cancel button 324 is pressed in step S211 (NO in step S607), the CPU 104 determines that the image is not to be output and the process returns to step S604.

In step S608, the CPU 104 stores the result of the latest image processing in the data storage unit 102 in a predetermined format or sends it to an external device (e.g., printer) via the communication unit 107. Storing the result of the image processing is referred to as image data storage processing. Further, the CPU 104 can change the GUI displayed on the display unit 103, and store the image in the data storage unit 102 according to the user's instruction or send the image to an external device via the communication unit 107.

After step S608, the process returns to step S604 and the CPU 104 waits until the user selects another image. In step S604, it is useful if a list of the image-processed image is displayed. On the other hand, in step S607, if the image is not to be output (NO in step S607), the CPU 104 discards the result of the image processing. Then the process returns to step S604.

In step S606, if the instruction to terminate the process is input (YES in step S606), then the process ends.

In this way, the image processing is performed.

According to the fifth exemplary embodiment, an effect similar to that obtained in the first exemplary embodiment can be obtained. Further, the user can do other work while the image processing is being executed in a collective manner. If the user makes correction as needed after the processing in a collective manner is finished, operability will be furthermore enhanced.

The processes in the flowchart illustrated in FIG. 5 can also be applied to the fifth exemplary embodiment. Further, the image processing executed in the second to the fourth exemplary embodiments can also be executed in the fifth exemplary embodiment.

Although the input unit 101, the data storage unit 102, and the display unit 103 are included in the image processing apparatus in FIG. 1, all of the aforementioned exemplary embodiments do not necessarily require that these units are included in the image processing apparatus. The units may be connected to the image processing apparatus from the outside in various methods.

According to the aforementioned exemplary embodiments, image processing conditions can be changed according to an instruction that is given from the outside of the image processing apparatus after the image processing is once automatically performed. Thus, a result that reflects the user's intention can be obtained while eliminating the need for a complicated setting by the user.

The present invention includes a case where a software program code which realizes a function of the above-described embodiments is supplied from a computer-readable recording medium by the CPU. Further, an operating system (OS) or the like running on the computer can perform a part or whole of the actual processing based on the instruction of the program code. This case can also realize the functions according to the aforementioned exemplary embodiments.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2008-169484 filed Jun. 27, 2008, which is hereby incorporated by reference herein in its entirety.

What is claimed is:

1. An image processing apparatus comprising:
a detecting unit configured to detect a plurality of predetermined image features from an image;
a ranking unit configured to perform ranking of the image features;
a determination unit configured to determine an image processing condition based on an image feature ranked highest in the ranking;
an image processing unit configured to perform image processing on the image based on the image processing condition;
an image display unit configured to display an image processed by the image processing unit;
a receiving unit configured to receive an instruction to change the image feature used by the determination unit to determine the image processing condition; and
a control unit configured to cause the determination unit to redetermine the image processing condition based on an image feature changed according to the instruction, to cause the image processing unit to reexecute the image processing of the image based on the redetermined image processing condition, and to cause the image display unit to display an image to which the image processing was reexecuted.

2. The image processing apparatus according to claim 1, further comprising a feature display unit configured to display the image feature used in determining the image processing condition.

3. The image processing apparatus according to claim 2, wherein the feature display unit displays the image feature by superposing the image feature on the image displayed by the image display unit.

4. The image processing apparatus according to claim 2, wherein the feature display unit distinguishably displays the image feature used in determining the image processing condition and another image feature, and wherein the instruction to change the image feature includes selection of the another image feature.

5. The image processing apparatus according to claim 2, wherein the feature display unit distinguishably displays the image feature used in determining the image processing condition and another image feature, and wherein the instruction to change the image feature includes addition of a new image feature.

6. The image processing apparatus according to claim 1, further comprising a condition changing unit configured to change a condition of the image processing in response to an instruction from an external device; and wherein the control unit causes the image processing unit to reexecute the image processing of the image based on the image processing condition changed by the condition changing unit, and causes the image display unit to display an image to which the image processing was reexecuted.

7. The image processing apparatus according to claim 1, wherein if the predetermined image feature does not exist in the image, the detecting unit outputs information that the predetermined image feature does not exist in the image.

8. The image processing apparatus according to claim 1, wherein the detecting unit detects a predetermined object in the image as the image feature.

9. The image processing apparatus according to claim 8, wherein the detecting unit detects a human face as the predetermined object.

10. The image processing apparatus according to claim 8, wherein the detecting unit detects a skin color area as the predetermined object.

11. The image processing apparatus according to claim 8, wherein the image processing unit adjusts brightness of the image as the image processing.

12. The image processing apparatus according to claim 1, wherein the detecting unit detects a straight line component of the image as the image feature.

13. The image processing apparatus according to claim 12, wherein the image processing unit rotates the image in the image processing.

14. The image processing apparatus according to claim 1, wherein the detecting unit detects an image area assumed to have been white that includes one or more pixels as the image feature.

15. The image processing apparatus according to claim 14, wherein the image processing unit performs color balance adjustment of the image in the image processing.

16. The image processing apparatus according to claim 1, wherein the detecting unit detects a type of a candidate scene of the image as the image feature.

17. The image processing apparatus according to claim 1, wherein the image processing condition is a parameter used for the image processing.

18. The image processing apparatus according to claim 1, further comprising a condition display unit configured to display an image processing condition used for the image processing of the image displayed on the image display unit.

19. An image processing method comprising:
detecting a plurality of predetermined image features from an image;
performing ranking of the image features;
determining an image processing condition based on an image feature ranked highest in the ranking;
performing image processing on the image based on the image processing condition;
displaying an image that was subjected to the image processing;
receiving an instruction to change the image feature used in determination of the image processing condition; and
redetermining the image processing condition based on an image feature changed according to the instruction, reexecuting the image processing of the image based on the redetermined image processing condition, and displaying an image to which the image processing was reexecuted.

20. A computer-readable storage medium that stores a program for instructing a computer to implement an image processing, the program comprising:
detecting a plurality of predetermined image features from an image;
performing ranking of the image features;
determining an image processing condition based on an image feature ranked highest in the ranking;
performing image processing on the image based on the image processing condition;
displaying an image which was subjected to the image processing;
receiving an instruction to change the image feature used in determination of the image processing condition; and
redetermining the image processing condition based on an image feature changed according to the instruction, reexecuting the image processing of the image based on the redetermined image processing condition, and displaying an image to which the image processing was reexecuted.
